(19) United States
(12) Patent Application Publication
(10) Pub. No.: US 2014/0155003 A1
(43) Pub. Date: Jun. 5, 2014

(54) QUADRATURE HYBRID COUPLER, AMPLIFIER, AND WIRELESS COMMUNICATION DEVICE

(71) Applicant: PANASONIC CORPORATION, Osaka (JP)

(72) Inventor: Toshifumi Nakatani, Kanagawa (JP)

(21) Appl. No.: 14/131,122

(22) PCT Filed: Nov. 16, 2012
(86) PCT No.: PCT/JP2012/007387

§ 371 Date: Jan. 6, 2014

(30) Foreign Application Priority Data
Jan. 5, 2012 (JP) 2012-000794

(51) Int. Cl. H01P 5/18; H04B 1/40

(52) U.S. Cl. CPC H01P 5/18; H04B 1/40
USPC 455/90.2; 333/115; 330/250

(57) ABSTRACT

A transformer (101) includes four terminals (N1 to N4), and parasitic resistances (109 and 110) are present in the transformer (101). A coupling capacitor (102) is provided between the terminals (N1 and N3), and a coupling capacitor (103) is provided between the terminals (N2 and N4). Shunt capacitors (104 to 107) are respectively provided between the respective terminals (N1 to N4) and a ground. Further, a phase shifter (112) is electrically connected to the terminal (N2), and a phase shifter (113) having a phase delay larger than that of the phase shifter (112) is connected to the terminal (N3).

### TECHNICAL FIELD

The present disclosure relates to a quadrature hybrid coupler, an amplifier and a wireless communication device used for a wireless communication.

### BACKGROUND ART

In recent years, in a mobile terminal (for example, a smart phone) that allows wireless communication, the demand for transmission and reception of a large amount of contents is increased. For example, a wireless communication in a millimeter wave band having a transmission rate of 1 Gbps or greater, particularly, in a 60 GHz band has attracted attention. As the semiconductor technology has advanced in recent years, it is expected that the wireless communication using the millimeter wave band becomes possible.

A quadrature hybrid coupler is used as one of circuit components used in a wireless system in the millimeter wave band. The quadrature hybrid coupler is a circuit component of one input and two outputs, for example, and ideally, two output signals have the same amplitude and a phase difference of 90 degrees therebetween. In the wireless communication in the millimeter wave band, the quadrature hybrid coupler is built in an integrated circuit (IC) of a wireless communication terminal. An output signal from the quadrature hybrid coupler is input to a quadrature modulator, a quadrature demodulator or a Doherty amplifier.

The quadrature hybrid coupler includes a type using a distributed constant circuit and a type using a lumped constant circuit. In the millimeter wave band, in order to realize a small quadrature hybrid coupler with less loss, for example, it is preferable to use an LC lumped constant circuit.

FIG. 18 is an equivalent circuit diagram of a quadrature hybrid coupler disclosed in Non-Patent Literature 1. In the quadrature hybrid coupler shown in FIG. 18, an input signal IN is input to a port N10, and output signals OUT1 and OUTQ are output from ports N11 and N12, respectively. In two output signals OUT1 and OUTQ, ideally, amplitudes are the same and phases are different by 90 degrees.

The quadrature hybrid coupler shown in FIG. 18 includes a transformer 11, coupling capacitors 12 and 13, shunt capacitors 14, 15, 16 and 17, and a termination resistance 18. Capacitance values of the coupling capacitors 12 and 13 are the same. Each capacitance value of the shunt capacitors 14, 15, 16 and 17 is 0.414 times a capacitance value of the coupling capacitors 12 and 13. A resistance value of the termination resistance 18 is generally set to 50 Ω.

FIG. 20 is a wiring layout diagram of a quadrature hybrid coupler disclosed in Patent Literature 1. In the quadrature hybrid coupler shown in FIG. 20, layouts of the shortest distances from respective output terminals (I, IX, Q and QX) to the next circuit are different from each other. Respective wirings 140I, 140IX, 140Q and 140QX that reach the next circuit 130 from respective output sections 110A to 110D of a phase shifter 110 are arranged in a meander shape, and the line lengths of the respective wirings are the same. Accordingly, the quadrature hybrid coupler shown in FIG. 20 reduces a phase error between output signals.

### CITATION LIST

### Patent Literature

Patent Literature 1: JP-A-2003-32003

### Non Patent Literature

Non-Patent Literature 1: R. C. Frye, et al., “A 2 GHz Quadrature Hybrid Implemented in CMOS Technology.” IEEE JSSC, vol. 38, no. 3, pp. 550-555, March 2003

### SUMMARY OF INVENTION

### Technical Problem

However, in the quadrature hybrid couplers disclosed in Patent Literature 1, an amplitude error and a phase error may occur between two output signals due to parasitic resistance generated in a transformer. In particular, the amplitude error and the phase error in the output signals from the quadrature hybrid coupler are increased as the frequency of a signal to be handled becomes high.

An object of the present disclosure is to provide a quadrature hybrid coupler, an amplifier and a wireless communication device that improve respective characteristics of an amplitude error and a phase error in a high frequency signal.

### Solution to Problem

According to an aspect of the present disclosure, there is provided a quadrature hybrid coupler including: a transformer that includes a first terminal, a second terminal, a third terminal and a fourth terminal; a first coupling capacitor that is provided between the first terminal and the third terminal; a second coupling capacitor that is provided between the second terminal and the fourth terminal; a first shunt capacitor, a second shunt capacitor, a third shunt capacitor and a fourth shunt capacitor that are respectively provided with the first terminal, the second terminal, the third terminal and the fourth terminal; a termination resistance that is connected to the fourth terminal; a termination capacitor that is connected to the fourth terminal and is connected in parallel with the termination resistance; a first phase shifter that is connected to the second terminal; and a second phase shifter that is connected to the third terminal, in which a phase delay amount of the second phase shifter is larger than a phase delay amount of the first phase shifter.

### Advantageous Effects of Invention

According to the present disclosure, it is possible to improve respective frequency characteristics of an amplitude error and a phase error in a high frequency signal.

### BRIEF DESCRIPTION OF DRAWINGS

In FIG. 1, (a) is a diagram illustrating a schematic configuration of a quadrature hybrid coupler with one input and two outputs according to a first embodiment, (b) is a diagram illustrating a schematic configuration of a quadrature hybrid coupler with two inputs and one output according to the first embodiment, and (c) is a diagram illustrating a circuit configuration of the quadrature hybrid coupler with one input and two outputs according to the first embodiment.

In FIG. 2, (a) is a graph illustrating a frequency characteristic of an amplitude difference when a difference between phase delay amounts of respective phase shifters is changed, and (b) is a graph illustrating a frequency characteristic of a phase difference when the difference between the phase delay amounts of the respective phase shifters is changed.

In FIG. 3, (a) is a graph illustrating a frequency characteristic of an amplitude difference when a capacitance value of a termination capacitor is changed, and (b) is a graph illustrating a frequency characteristic of a phase difference when the capacitance value of the termination capacitor is changed.

In FIG. 4, (a) is a graph illustrating a frequency characteristic of an amplitude difference when a resistance value of a termination resistance is changed, and (b) is a graph illustrating a frequency characteristic of a phase difference when the resistance value of the termination resistance is changed.

FIG. 5 is a diagram illustrating a circuit configuration of a quadrature hybrid coupler according to a modification example of the first embodiment.

In FIG. 6, (a) is a diagram illustrating a schematic configuration of a quadrature hybrid coupler using a phase shifter according to Example 1, (b) is a layout diagram of a coplanar transmission line, and (c) is a layout diagram of a quadrature hybrid coupler using the phase shifter according to Example 1.

In FIG. 7, (a) is a circuit diagram of a phase shifter according to Example 2, and (b) is a graph illustrating a simulation result of a frequency characteristic of a phase delay amount of the phase shifter shown in FIG. 7(a).

FIG. 8 is a diagram illustrating a circuit configuration of a quadrature hybrid coupler with one input and two outputs according to a second embodiment.

In FIG. 9, (a) is a graph illustrating a frequency characteristic of an amplitude difference when a resistance value of a parasitic resistance of a transformer is increased according to temperature increase, and (b) is a graph illustrating a frequency characteristic of a phase difference when the resistance value of the parasitic resistance of the transformer is increased according to temperature increase.

In FIG. 10, (a) is a graph illustrating a frequency characteristic of an amplitude difference when a capacitance value of a variable capacitor is changed from the frequency characteristic of the amplitude difference shown in FIG. 9(a), and (b) is a graph illustrating a frequency characteristic of a phase difference when the capacitance value of the variable capacitor is changed from the frequency characteristic of the phase difference shown in FIG. 9(b).

In FIG. 11, (a) is a graph illustrating a frequency characteristic of an amplitude difference when a resistance value of a variable resistance is changed from the frequency characteristic of the amplitude difference shown in FIG. 10(a), and (b) is a graph illustrating a frequency characteristic of a phase difference when the resistance value of the variable resistance is changed from the frequency characteristic of the phase difference shown in FIG. 10(b).

In FIG. 12, (a) is a diagram illustrating an example of a variable capacitor using a variable capacitance diode, and (b) is a diagram illustrating an example of a variable capacitor using a MEMS variable capacitor.

FIG. 13 is a diagram illustrating an example of a variable resistance using a field effect transistor.

FIG. 14 is a diagram illustrating a circuit configuration of an example of a voltage control circuit and a temperature sensor.

FIG. 15 is a block diagram illustrating an internal configuration of an amplifier according to a third embodiment.

FIG. 16 is a block diagram illustrating an internal configuration of a wireless communication apparatus according to a fourth embodiment.

FIG. 17 is a diagram illustrating a block diagram illustrating an internal configuration of a wireless communication apparatus according to a modification example of the fourth embodiment.

FIG. 18 is an equivalent circuit diagram of a quadrature hybrid coupler disclosed in Non-Patent Literature 1.

In FIG. 19, (a) is an equivalent circuit diagram of a quadrature hybrid coupler including a transformer that includes a parasitic resistance in the related art, (b) is a graph illustrating a frequency characteristic of an amplitude error of the quadrature hybrid coupler shown in FIG. 19(a), and (c) is a graph illustrating a frequency characteristic of a phase error of the quadrature hybrid coupler shown in FIG. 19(a).

FIG. 20 is a diagram illustrating a wiring layout of a quadrature hybrid coupler disclosed in Patent Literature 1.

### DESCRIPTION OF EMBODIMENTS

First, before describing the respective embodiments of the present disclosure, parasitic resistances 109 and 110 of a transformer 101 of a quadrature hybrid coupler in the related art shown in FIG. 19 will be described. FIG. 19(a) is an equivalent circuit diagram of the related art quadrature hybrid coupler including the transformer 101 that includes the parasitic resistances 109 and 110. FIG. 19(b) is a diagram illustrating a frequency characteristic of an amplitude difference in the quadrature hybrid coupler shown in FIG. 19(a). FIG. 19(c) is a diagram illustrating a frequency characteristic of a phase difference in the quadrature hybrid coupler shown in FIG. 19(a). The quadrature hybrid coupler shown in FIG. 19 is a quadrature hybrid coupler in the related art for comparison with a quadrature hybrid coupler according to the present disclosure.

In the quadrature hybrid coupler shown in FIG. 19(a), the parasitic resistances 109 and 110 are present in the transformer 101. Thus, if the frequency of a signal to be handled is high, an amplitude error and a phase error of an output signal become noticeable due to the influence of the parasitic resistances 109 and 110.

A coil CL1 and a coil CL2 of the transformer 101 are inductively coupled to each other, and thus, the quadrature hybrid coupler shown in FIG. 19(a) is referred to as an inductively coupled quadrature hybrid coupler. Further, in the following description, among two output signals (I signal and Q signal) from the quadrature hybrid coupler, the I signal represents a signal having the same phase with respect to an input signal, and the Q signal represents a signal orthogonal to the input signal.

The amplitude difference shown in FIG. 19(b) represents an amplitude difference between two output signals (I signal and Q signal). Ideally, the amplitude difference is not present and becomes zero dB. If the amplitude difference is not zero dB, an amplitude error occurs between two output signals (I signal and Q signal).

The phase difference shown in FIG. 19(c) represents a phase difference between two output signals (I signal and Q signal). Ideally, the phase difference becomes 90 degrees. If the phase difference is not 90 degrees, a phase error occurs between two output signals (I signal and Q signal).

In FIGS. 19(b) and 19(c), when resistance values R1 of the parasitic resistances 109 and 110 are 0Ω, the amplitude difference and the phase difference become 0 dB and 90 degrees, respectively. In this case, the amplitude error and the phase error barely occur, and respective frequency characteristics of the amplitude error and the phase error become approximately flat. If the resistance values R1 of the parasitic resistances 109 and 110 are increased to 1Ω or 2Ω, the phase difference shown in FIG. 19(c) is considerably deviated from 90 degrees, and the phase error is increased as the frequency is increased.

If the phase difference between two output signals is not 90 degrees and the phase error occurs, for example, modulation accuracies and reception sensitivities of a quadrature modulator and a quadrature demodulator, and amplification efficiency of an amplifier including the quadrature hybrid coupler are degraded.

When the quadrature hybrid coupler disclosed in Patent Literature 1 mentioned above is applied to the correction of the phase error due to the parasitic resistances 109 and 110 of the transformer 101, it is difficult to make the frequency characteristic of the phase error flat with respect to the frequency. In Patent Literature 1, since adjustment is performed for a line length of a transmission line and the frequency characteristic is not corrected, it is difficult to obtain a desired flat frequency characteristic.

Hereinafter, respective embodiments of the present disclosure will be described with reference to the accompanying drawings.

### First Embodiment

FIG. 1(a) is a diagram illustrating a schematic configuration of a quadrature hybrid coupler 100 with one input and two outputs according to a first embodiment. FIG. 1(b) is a diagram illustrating a schematic configuration of a quadrature hybrid coupler 100 with two inputs and one output according to the first embodiment. FIG. 1(c) is a diagram illustrating a circuit configuration of the quadrature hybrid coupler 100 with one input and two outputs according to the first embodiment.

The quadrature hybrid coupler 100 shown in FIG. 1(a) includes a coupling section 90, a phase shifter 112, a phase shifter 113, and at least three ports P1, P2 and P3. A delay amount of the phase shifter 113 is larger than a delay amount of the phase shifter 112.

In the quadrature hybrid coupler 100 shown in FIG. 1(a), an input signal IN is input to the port P1, an output signal IOUT having the same phase as that of the input signal IN is output from the port P2, and an output signal QOUT orthogonal to the input signal IN, that is, having a phase difference of 90 degrees with respect to the input signal IN is output from the port P3.

The quadrature hybrid coupler 100 shown in FIG. 1(b) has the same configuration as that of the quadrature hybrid coupler 100 shown in FIG. 1(a), but the form of signal input and output is different therefrom. That is, in the quadrature hybrid coupler 100 shown in FIG. 1(b), an input signal IN1 (I signal) is input to the port P2, and an input signal IN2 (Q signal) having a phase difference of 90 degrees with reference to the input signal IN1 (I signal) is input to the port P3. An output signal OUT is output from the port P1.

The coupling section 90 will be specifically described with reference to FIG. 1(c).

The coupling section 90 includes a transformer 101, coupling capacitors 102 and 103, and shunt capacitors 104, 105, 106 and 107. The transformer 101 includes inductively coupled coils (inductors) CL1 and CL2. The quadrature hybrid coupler 100 shown in FIG. 1(c) has the same form of signal input and output as in the quadrature hybrid coupler 100 shown in FIG. 1(a).

The transformer 101 includes four terminals N1 to N4, and parasitic resistances 109 and 110. The coupling capacitor 102 is disposed between the terminals N1 and N3, the coupling capacitor 103 is disposed between the terminals N2 and N4, and the shunt capacitors 104 to 107 are disposed between the respective terminals N1 to N4 and a ground, respectively. In parallel with the shunt capacitor 107, a variable resistance that is a termination resistance 108 and a variable capacitor that is a termination capacitor 111 are connected, respectively.

The phase shifter 112 is connected to the terminal N2 of the transformer 101 through a terminal N6. The phase shifter 113 is connected to the terminal N3 of the transformer 101 through a terminal N7. A terminal N5 is connected to the port P1 to which the input signal IN is input, and a terminal N8 is terminated by the termination resistance 108 and the termination capacitor 111.

FIG. 2(a) is a graph illustrating a frequency characteristic of an amplitude difference when a difference between phase delay amounts of the respective phase shifters 112 and 113 is changed. FIG. 2(b) is a graph illustrating a frequency characteristic of a phase difference when the difference between the phase delay amounts of the respective phase shifters 112 and 113 is changed. The frequency characteristics shown in FIGS. 2(a) and 2(b) are simulation results when any one of 0 degree, 5.5 degrees and 7.5 degrees is used as the difference between the phase delay amounts, for example, which are indicated by a dotted chain line, a dashed line, and a solid line, respectively. In FIG. 2(a), the respective frequency characteristics of the amplitude difference are approximately the same.

In FIGS. 2(a) and 2(b), the delay amount is represented as a phase delay amount when a signal of a frequency of 61.5 GHz is handled. Further, the parasitic resistances 109 and 110 of the transformer 101 are set to 3.5Ω, respectively. In the frequency characteristic indicated by the dashed line in FIG. 2(b), when the delay amount is 5.5 degrees, that is, when the delay amount of the output signal QOUT is larger by 5.5 than the output signal IOUT, the phase error approximately becomes zero degree at 62 GHz. Here, when the delay amount is 5.5 degrees, deviation of the phase difference with respect to the frequency is large.

In the quadrature hybrid coupler 100 of the present embodiment, for example, the delay amount is set to 7.5 degrees, and capacitance values of variable capacitances and resistance values of variable resistances of the termination capacitor 111 and the termination resistance 108 are used to improve the frequency characteristics of the amplitude difference and the phase difference in a desired frequency band.

FIG. 3(a) is a graph illustrating a frequency characteristic of an amplitude difference when a capacitance value of the termination capacitor 111 is changed. FIG. 3(b) is a graph illustrating a frequency characteristic of a phase difference when the capacitance value of the termination capacitor 111 is changed.

In FIGS. 3(a) and 3(b), any one capacitance value among three values of 0 fF (femtofarad), 25 fF and 50 fF is used as a capacitance value Cterm of the termination capacitor 111. Here, 0 fF is equivalent to a state where the termination capacitor 111 is not connected.

In FIGS. 3(a) and 3(b), the respective frequency characteristics of the amplitude difference and the phase difference when the capacitance value Cterm of the termination capacitor 111 is 0 fF are indicated by a dotted chain line, the respective frequency characteristics of the amplitude difference and the phase difference when the capacitance value Cterm of the termination capacitor 111 is 25 fF are indicated by a dashed line, and the respective frequency characteristics of the amplitude difference and the phase difference when the capacitance value Cterm of the termination capacitor 111 is 50 fF are indicated by a solid line.

In FIG. 3(b), when the capacitance value Cterm of the termination capacitor 111 is 50 fF, the phase error is approximately 0 degree, and the frequency characteristic of the phase difference becomes approximately flat. In FIG. 3(a), when the capacitance value Cterm of the termination capacitor 111 is 50 fF, the amplitude error is slightly deviated from 0 dB.

FIG. 4(a) is a graph illustrating a frequency characteristic of an amplitude difference when a resistance value of the termination resistance 108 is changed. FIG. 4(b) is a graph illustrating a frequency characteristic of a phase difference when the resistance value of the termination resistance 108 is changed.

FIGS. 4(a) and 4(b), the respective frequency characteristics of the amplitude difference and the phase difference when the resistance value Rterm of the termination resistance 108 is 50Ω are indicated by a dotted chain line, and the respective frequency characteristics of the amplitude difference and the phase difference when the resistance value Rterm of the termination resistance 108 is 40Ω are indicated by a solid line.

In FIGS. 4(a) and 4(b), when the capacitance value Cterm of the termination capacitor 111 is 50 fF, if the frequency characteristic of the amplitude difference is slightly deviated from 0 dB, the resistance value of the resistance value Rterm of the termination resistance 108 is reduced to 40Ω from 50Ω. Thus, the quadrature hybrid coupler 100 corrects the deviation of the frequency characteristic of the amplitude difference when the capacitance value Cterm of the termination capacitor 111 is 50 fF, thereby improving the respective frequency characteristics of the amplitude difference and the phase difference. In FIG. 4(b), when the resistance value of the resistance value Rterm of the termination resistance 108 is reduced to 40Ω from 50Ω, the frequency characteristic of the phase difference is barely changed.

As described above, in the quadrature hybrid coupler 100 of the present embodiment, the delay amount of the phase shifter 113 is larger than the delay amount of the phase shifter 112, and the resistance value of the termination resistance 108 and the capacitance value of the termination capacitor 111 are variable. Thus, the quadrature hybrid coupler 100 can reduce the amplitude error and the phase error, and can improve the respective frequency characteristics of the amplitude error and the phase error to become flat.

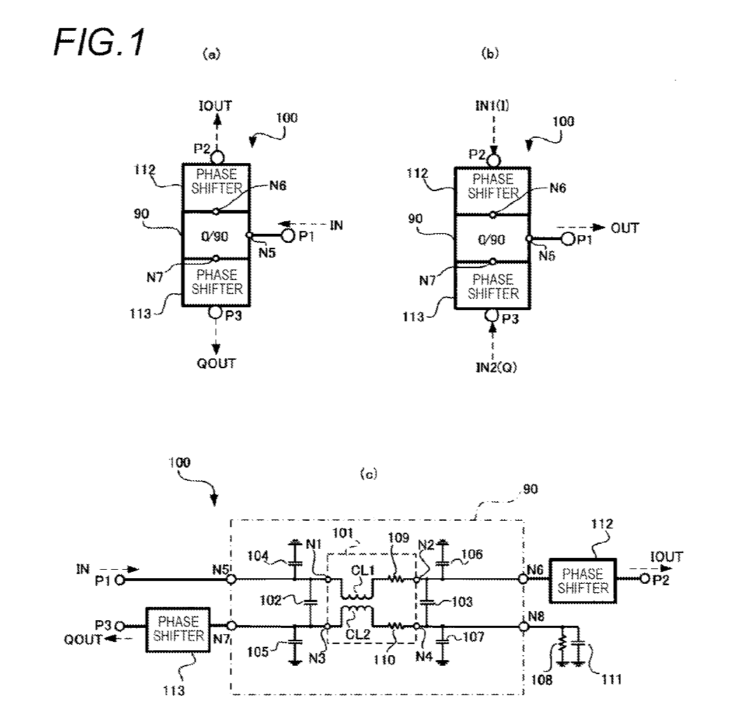

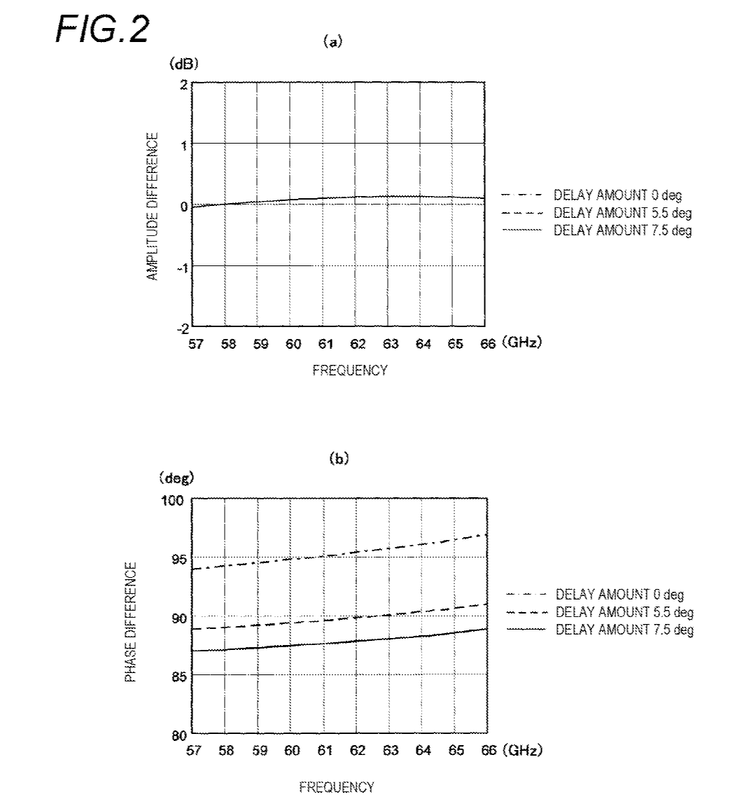

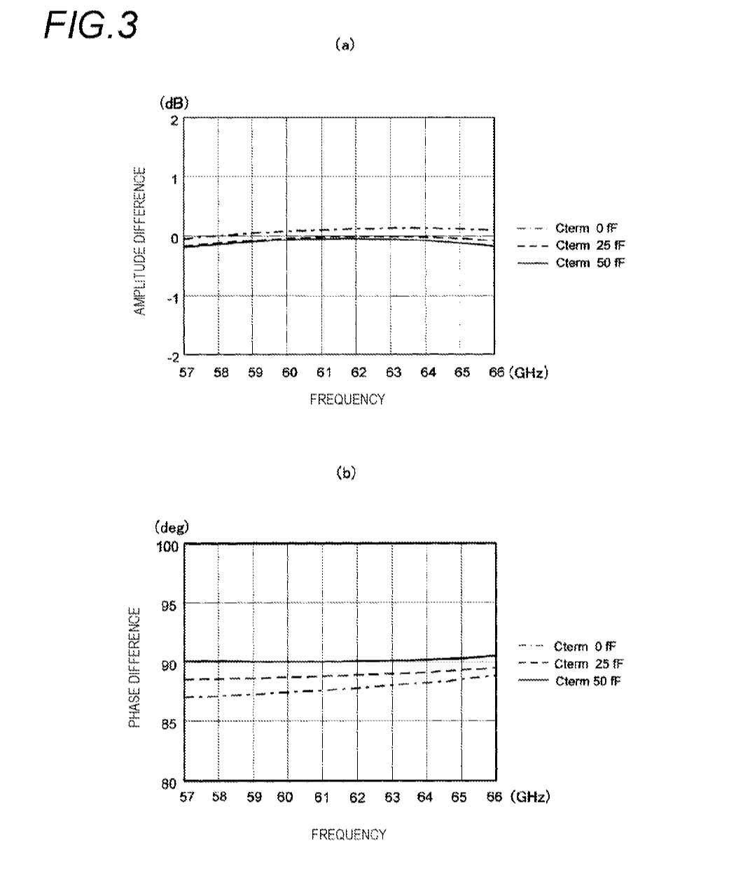

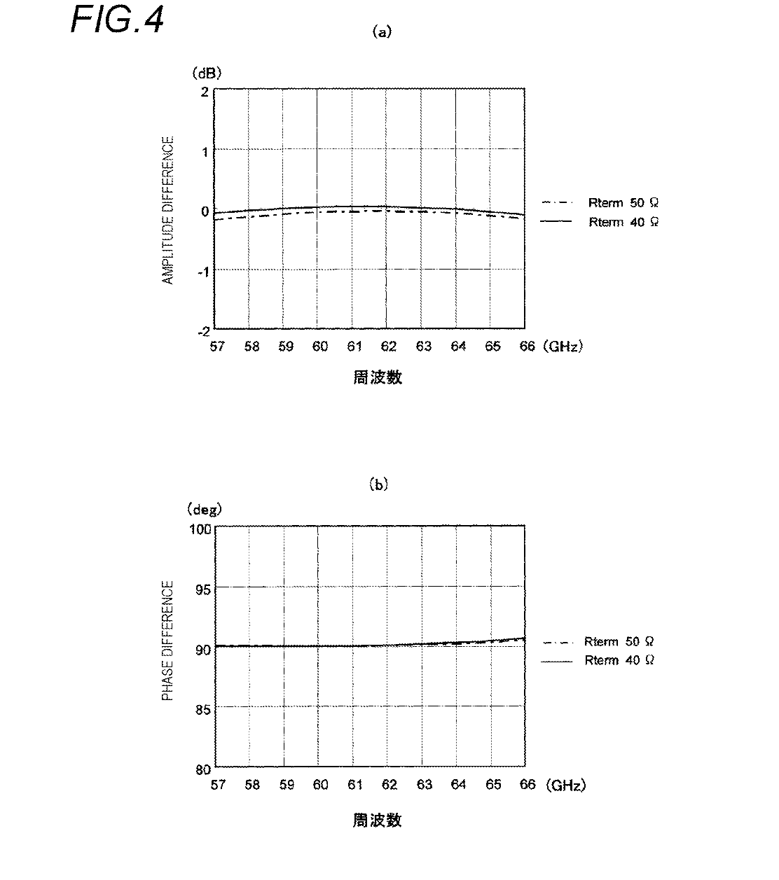

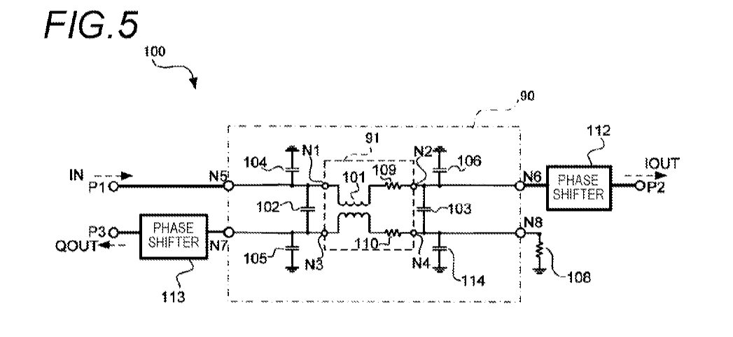

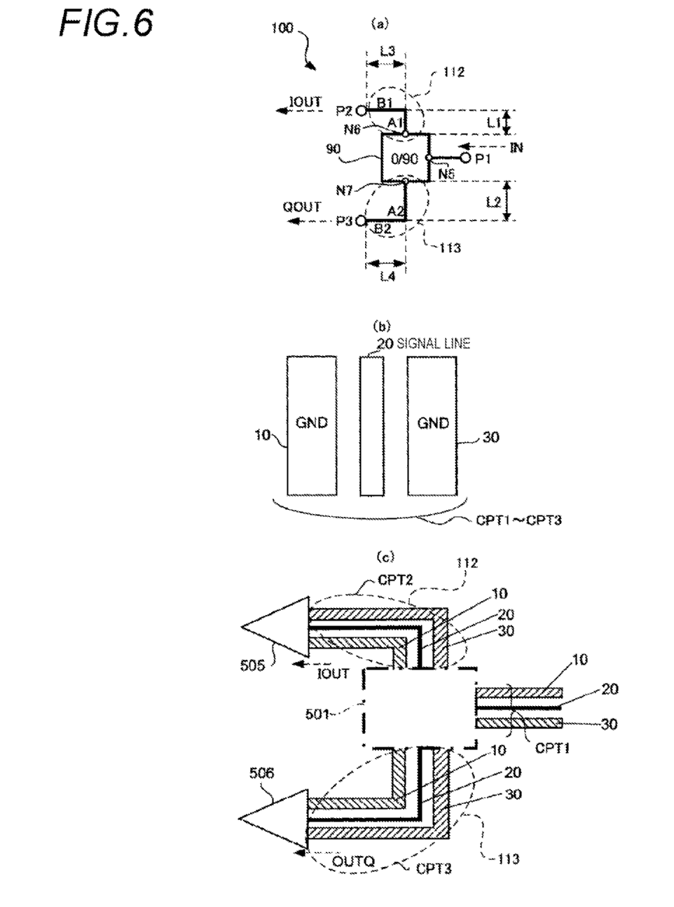

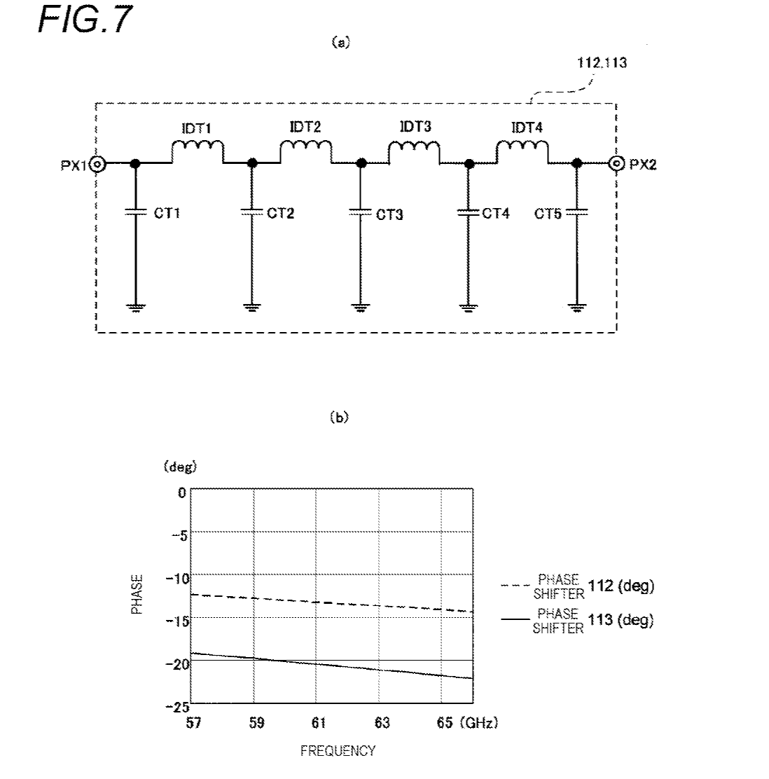

In the quadrature hybrid coupler 100 of the present embodiment, the shunt capacitor 107 and the termination capacitor 111 are dividedly connected, but the present invention is not limited thereto (see FIG. 5). FIG. 5 is a diagram illustrating a circuit configuration of a quadrature hybrid coupler according to a modification example of the first embodiment. With respect to the quadrature hybrid coupler 100 shown in FIG. 5 and the quadrature hybrid coupler 100 shown in FIG. 1, the same reference numerals are given to the same content, and description thereof will be omitted, and different contents will be described with different reference numerals given thereto.

In the quadrature hybrid coupler 100 shown in FIG. 5, the shunt capacitor 107 and the termination capacitor 111 connected in parallel in the quadrature hybrid coupler 100 shown in FIG. 1(c) are combined and integrated to a shunt capacitor 114.

The difference between the shunt capacitor 114 and the shunt capacitor 107 is in that the shunt capacitor 114 has a capacitance value larger than each of the shunt capacitors 104 to 106 while the shunt capacitor 107 and each of the shunt capacitors 104 to 106 have the same capacitance value. In the quadrature hybrid coupler 100 shown in FIG. 5, since the shunt capacitor 107 and the termination capacitor 111 are combined, it is not necessary to consider a parasitic capacitance unique to each shunt capacitor in design, compared with a case where the shunt capacitor 107 and the termination capacitor 111 are individually provided.

Next, the phase shifters 112 and 113 will be described with reference to FIG. 6. FIG. 6(a) is a diagram illustrating a schematic configuration of a quadrature hybrid coupler using the phase shifters 112 and 113 according to Example 1. FIG. 6(b) is a layout diagram of a coplanar transmission line. FIG. 6(c) is a layout diagram of a quadrature hybrid coupler using the phase shifters 112 and 113 according to Example 1. In FIG. 6, sections common to those in FIG. 1 are given the same reference numerals, and description thereof will be omitted.

The phase shifters 112 and 113 shown in FIG. 6(a) are configured by a coplanar transmission line. The phase shifter 112 includes a coplanar transmission line A1 and a coplanar transmission line B1 connected to the coplanar transmission line A1 at an angle of 90 degrees. The length of the coplanar transmission line A1 is L1, and the length of the coplanar transmission line B1 is L3.

The phase shifter 113 includes a coplanar transmission line A2 and a coplanar transmission line B2 connected to the coplanar transmission line A2 at an angle of 90 degrees. The length of the coplanar transmission line A2 is L2, and the length of the coplanar transmission line B2 is IA.

In the phase shifters 112 and 113 shown in FIG. 6(a), the respective lengths of the coplanar transmission line B1 and the coplanar transmission line B2 are the same, but the length of the coplanar transmission line A1 is longer than the length of the coplanar transmission line A2. Thus, the phase shifter 113 can delay a large phase delay amount compared with the phase shifter 112. According to the phase delay amounts of the phase shifter 112 and the phase shifter 113, the lengths of the respective coplanar transmission lines are appropriately adjusted.

In coplanar transmission lines CPT1, CPT2 and CPT3 shown in FIG. 6(c), for example, a signal line 20 in which a conductive foil is patterned, and ground (GND) patterns 10 and 30 that are disposed in parallel on opposite sides of the signal line 20 are formed on a substrate. The coplanar transmission line CPT is formed by patterning of a known semiconductor manufacturing method by depositing a conductor on the surface of the substrate, for example, and may employ a transmission line suitable for a high frequency signal with a simple structure.

A coupling section 501 shown in FIG. 6(c) corresponds to the coupling section 90 shown in FIG. 1, and includes the transformer 101, the coupling capacitors 102 and 103, the shunt capacitors 104 to 107, and the termination resistance 108 and the termination capacitor 111.

The coplanar transmission line CPT1 is a transmission line of an input signal input to the quadrature hybrid coupler 100. The coplanar transmission line CPT2 is a transmission line corresponding to the phase shifter 112, and the coplanar transmission line CPT3 is a transmission line corresponding to the phase shifter 113.

Amplifiers 505 and 506 are connected to the coplanar transmission lines CPT2 and CPT3, respectively. In the layout of the quadrature hybrid coupler 100 shown in FIG. 6(c), according to the line lengths of the coplanar transmission lines CPT2 and CPT3 to the respective amplifiers 505 and 506 from the coupling section 501, the phase delay amounts of the phase shifters 112 and 113 are determined. That is, the difference between the respective phase delay amounts of the phase shifters 112 and 113 is set.

FIG. 7(a) is a circuit diagram of the phase shifters 112 and 113 according to Example 2, and FIG. 7(b) is a graph illustrating a simulation result of phase delay. In FIG. 7(a), the phase shifters 112 and 113 correspond to an LPF phase shifter using an LC lumped constant element. That is, the phase shifters 112 and 113 include inductors IDT1 to IDT4 connected in series, shunt capacitors CT1 to CT5, and terminals PX1 and PX2. Respective capacitances of the shunt capacitors CT1 to CT5 are the same.

FIG. 7(b) is a graph illustrating a simulation result of frequency characteristics of the phase delay amounts of the phase shifters 112 and 113 shown in FIG. 7(a). A dashed line in FIG. 7(b) represents the frequency characteristic of the phase shifter 112, and a solid line represents the frequency characteristic of the phase shifter 113. Capacitance values of the respective capacitors (CT1 to CT5) of the phase shifter 112 are larger 1.9 times than capacitance values of the respective capacitors (CT1 to CTS5) of the phase shifter 113. Values of the respective inductors IDT1 to IDT4 of the phase shifters 112 and 113 are the same. Accordingly, the difference between the phase delay amounts of the phase shifters 112 and 113 is about 7.5 degrees in a frequency of 61.5 GHz.

### Second Embodiment

Since a transformer of a quadrature hybrid coupler is formed by metal (for example, aluminum, copper or gold), if temperature is increased, a parasitic resistance of the transformer is also increased. Thus, in a quadrature hybrid coupler, if the ambient temperature is increased, a phase error between output signals is further increased. Thus, performances of a quadrature modulator, a quadrature demodulator and a Doherty amplifier are degraded.

In the present embodiment, a quadrature hybrid coupler that reduces frequency characteristics of an amplitude error and a phase error when a high frequency signal is used, and reduces an amplitude error and a phase error occurring due to a parasitic resistance of a transformer increased according to temperature increase will be described.

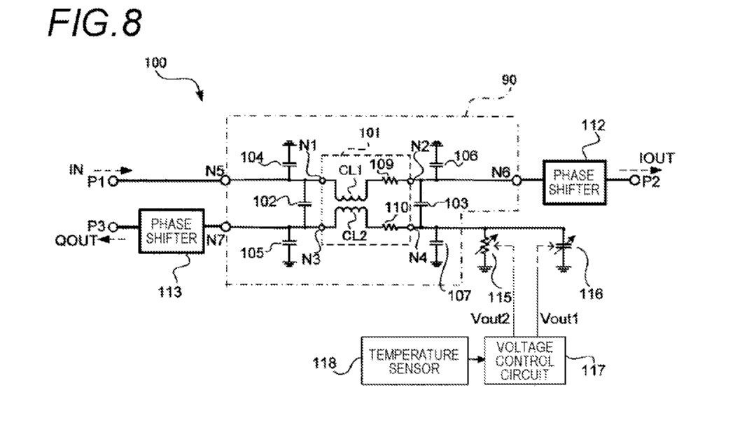

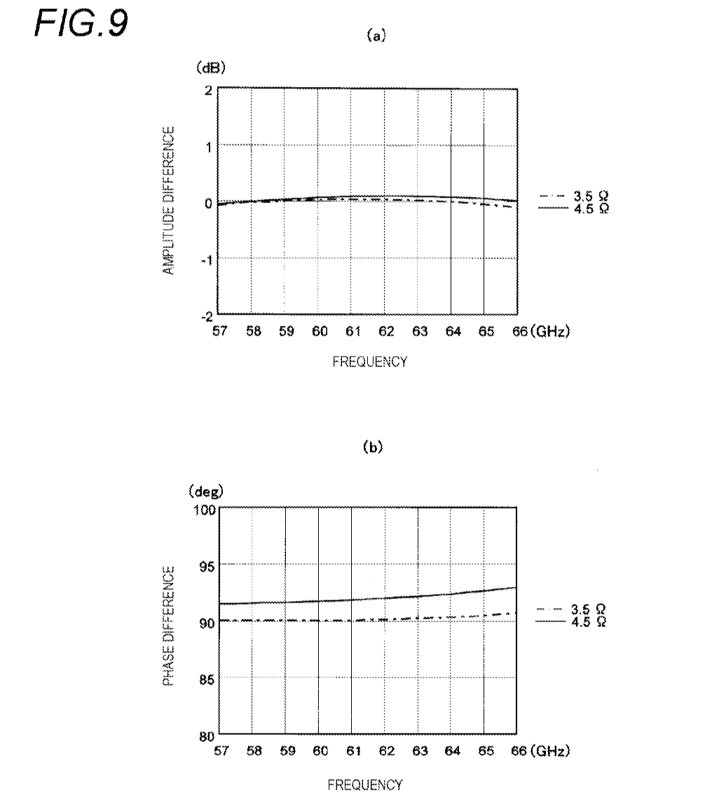

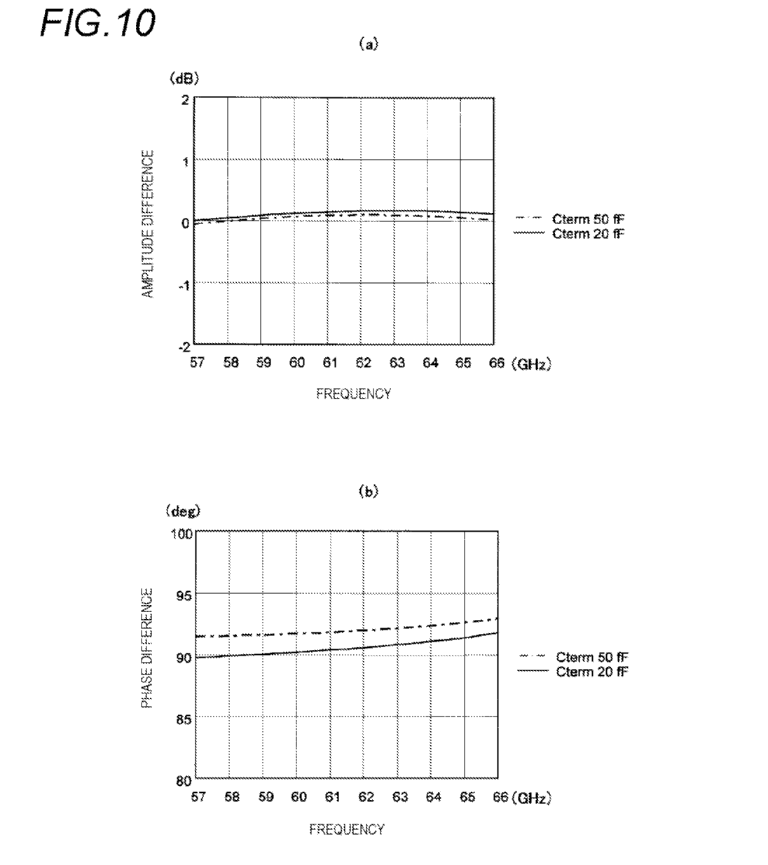

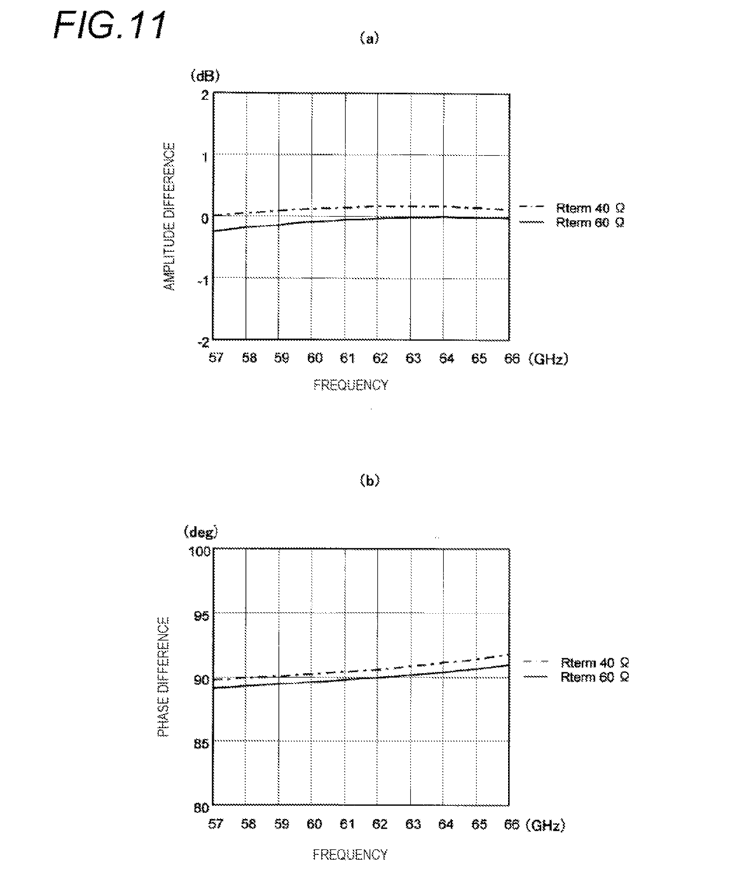

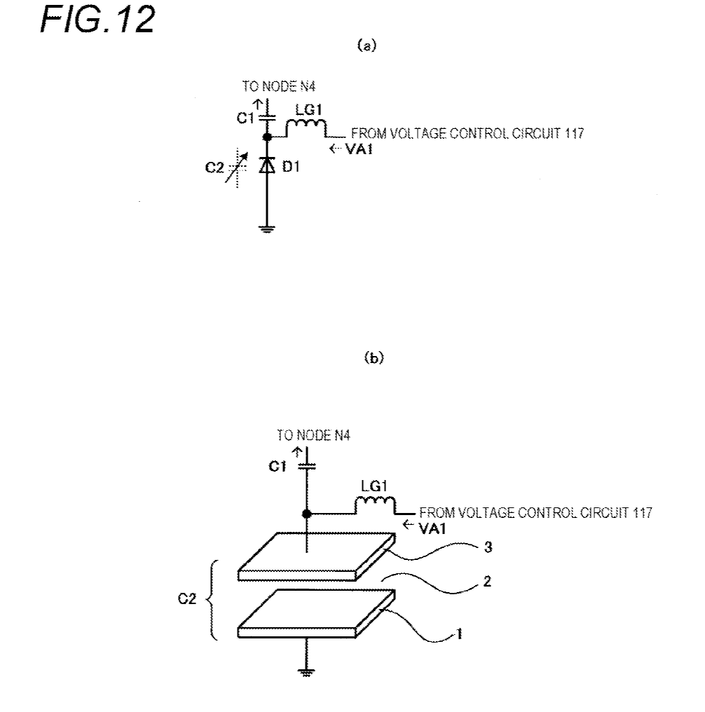

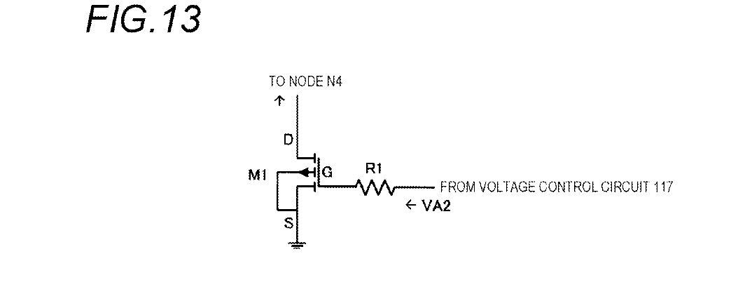

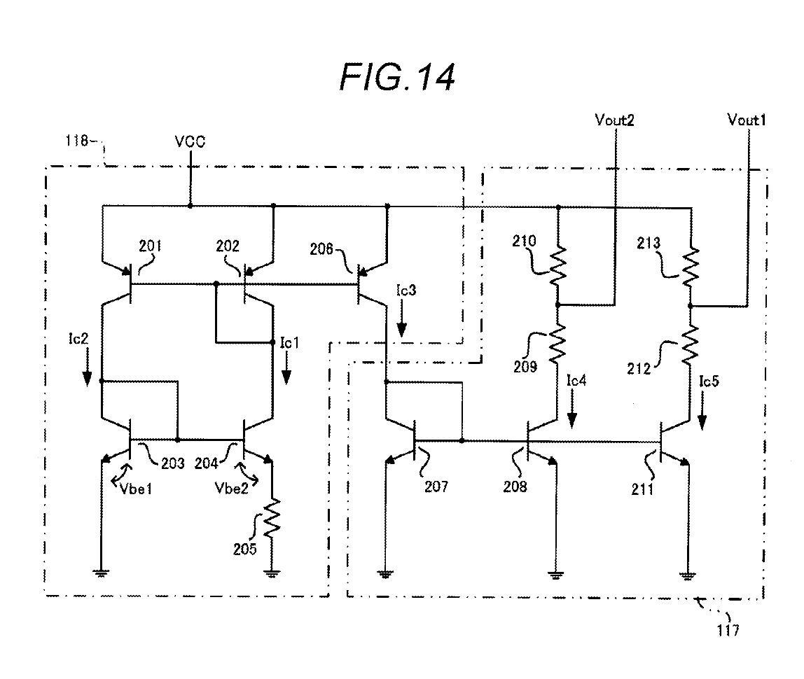

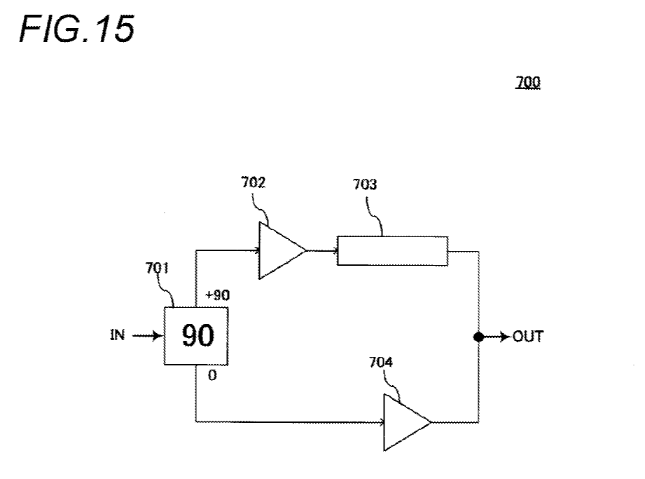

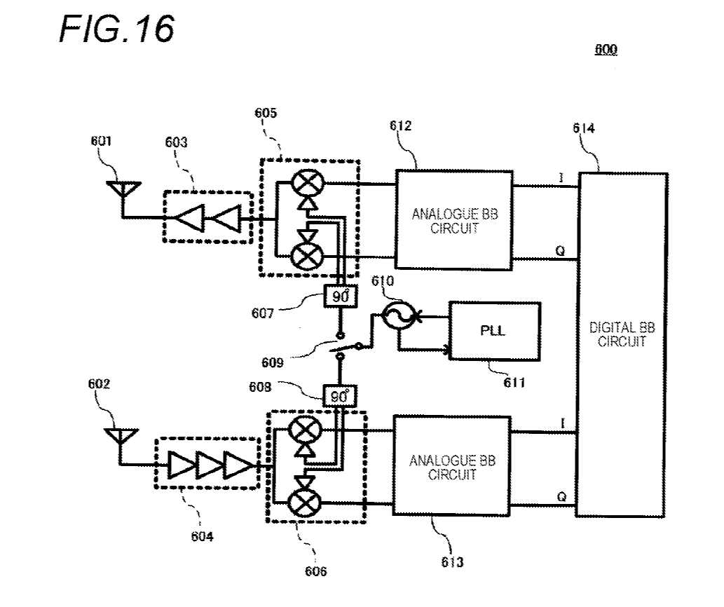

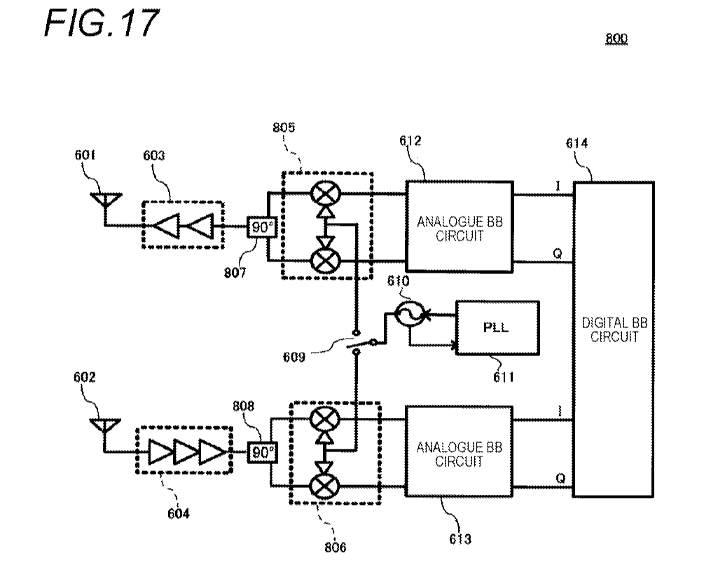

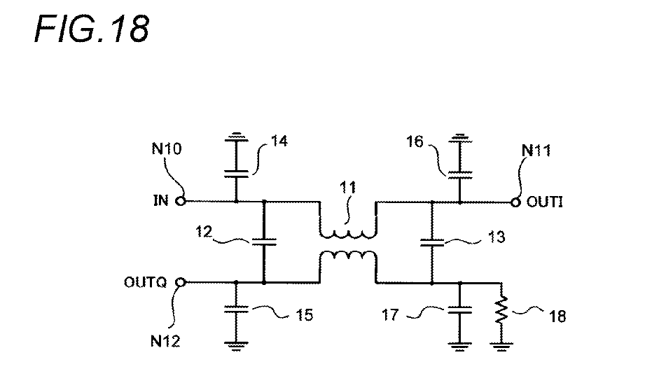

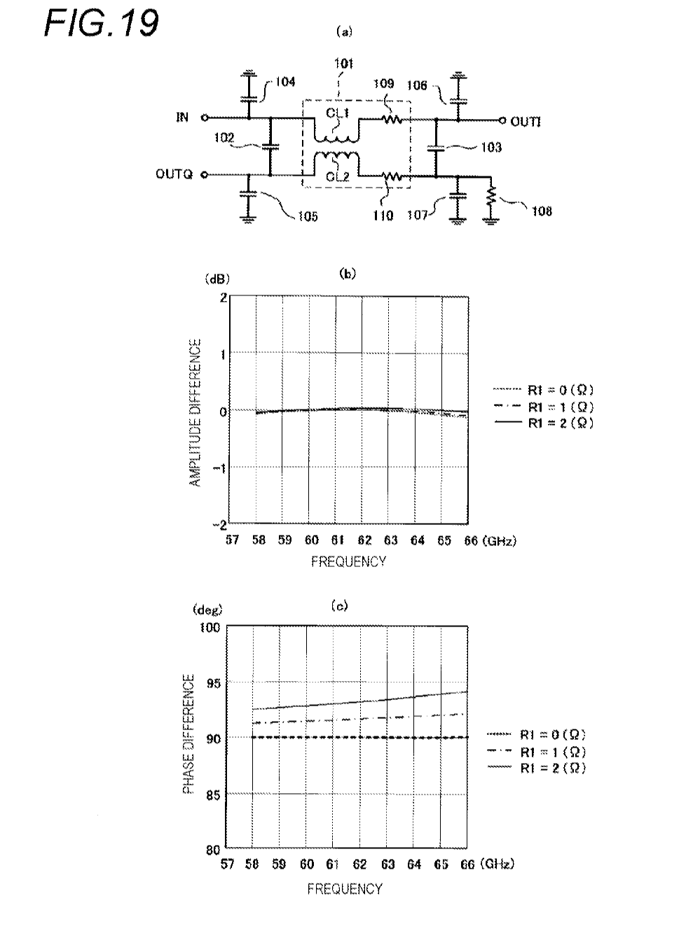

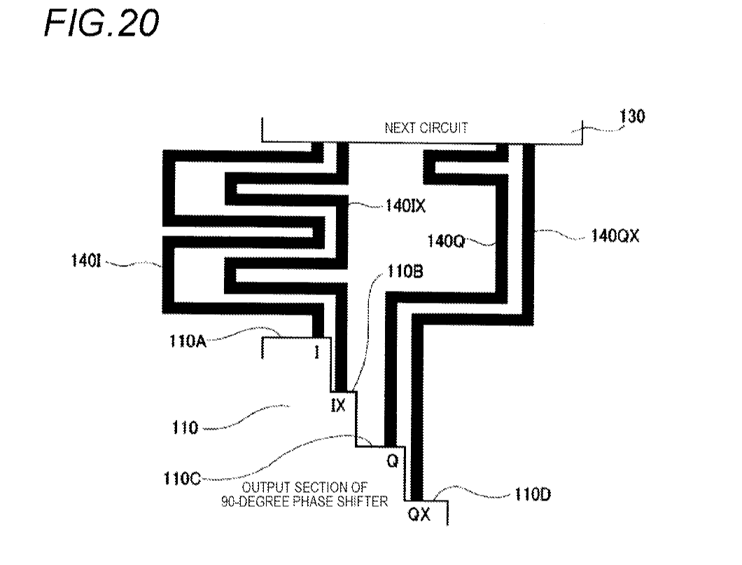

FIG. 8 is a diagram illustrating a circuit configuration of a quadrature hybrid coupler 100 with one input and two outputs according to a second embodiment. In FIG. 8, the same reference numerals are given to the same components as in the respective sections shown in FIG. 1(c), and description thereof will be simplified or omitted. The quadrature hybrid coupler 100 shown in FIG. 8 includes a coupling section 90, phase shifter 112 and 113, a variable resistance 115 that is a termination resistance, a variable capacitor 116 that is a termination capacitor, a voltage control circuit 117 and a temperature sensor 118.

In the quadrature hybrid coupler 100 shown in FIG. 8, the configuration of the coupling section 90 is the same as the configuration of the coupling section 90 of the quadrature hybrid coupler 100 shown in FIG. 1, and the variable resistance 115 and the variable capacitor 116 are connected in parallel with the shunt capacitor 107. That is, in the quadrature hybrid coupler 100 shown in FIG. 8, the variable resistance 115 is used instead of the termination resistance 108 shown in FIG. 1(c), and the variable capacitor 116 is used instead of the termination capacitor 111.

The variable resistance 115 and the variable capacitor 116 are controlled by the voltage control circuit 117. If temperature is increased, a resistance value of the variable resistance 115 is increased, and a capacitance value of the variable capacitor 116 is decreased. The quadrature hybrid coupler 100 shown in FIG. 8 sets the resistance value of the variable resistance 115 and the capacitance value of the variable capacitor 116 to predetermined values on the basis of a control voltage from the voltage control circuit 117. The voltage control circuit 117 changes the control voltage according to an output from the temperature sensor 118.

Accordingly, the quadrature hybrid coupler 100 makes respective frequency characteristics of an amplitude error and a phase error at room temperature flat, for example, and can reduce variation of the amplitude error and the phase error when the ambient temperature is increased.

Hereinafter, a specific operation of the quadrature hybrid coupler 100 shown in FIG. 8 will be described.

The voltage control circuit 117 adjusts the resistance value of the variable resistance 115 on the basis of an output voltage Vout1, and adjusts the capacitance value of the variable capacitor 116 on the basis of an output voltage Vout2. The temperature sensor 118 detects the ambient temperature of the quadrature hybrid coupler 100. The output from the temperature sensor 118 is input to the voltage control circuit 117.

The voltage control circuit 117 generates respective control voltages of the variable resistance 115 and the variable capacitor 116 on the basis of the output voltage from the temperature sensor 118. The resistance value and the capacitance value of the variable resistance 115 and the variable capacitor 116 are changed according to the atmospheric temperature (ambient temperature). Thus, the voltage control circuit 117 and the temperature sensor 118 correct variation of the phase error due to temperature change of the parasitic resistances 109 and 110 of the transformer 101, for example.

Hereinafter, the frequency characteristic of the phase error based on the atmospheric temperature (ambient temperature) and the correction of the frequency characteristic will be described with reference to FIGS. 9 to 11.

FIG. 9(a) is a graph illustrating a frequency characteristic of an amplitude difference when a resistance value of a transformer is increased according to temperature increase. FIG. 9(b) is a graph illustrating a frequency characteristic of a phase difference when the resistance value of the transformer is increased according to temperature increase.

In FIGS. 9(a) and 9(b), a frequency characteristic of an amplitude difference in a resistance value of 3.5Ω and a frequency characteristic of an amplitude difference in a resistance value of 4.5Ω are shown in consideration of increase in resistance values of the parasitic resistances 109 and 110 of the transformer 101 according to increase in the atmospheric temperature. The resistance value of the variable capacitor 116 is a predetermined value (50 fF).

In FIG. 9(a), the frequency characteristic of the amplitude difference in the resistance value of 3.5Ω is indicated by a dotted chain line, and the frequency characteristic of the amplitude difference in the resistance value of 4.5Ω is indicated by a solid line. In FIG. 9(b), the frequency characteristic of the phase difference in the resistance value of 3.5Ω is indicated by a dotted chain line, and the frequency characteristic of the phase difference in the resistance value of 4.5Ω is indicated by a solid line. According to FIG. 9(b), the frequency characteristic of the phase difference is larger in phase error, that is, in deviation from the ideal angle of 90 degrees, than the frequency characteristic of the amplitude difference shown in FIG. 9(a).

FIG. 10(a) is a graph illustrating a frequency characteristic of an amplitude difference when the capacitance value of the variable capacitor 116 is changed from the frequency characteristic of the amplitude difference shown in FIG. 9(a). FIG. 10(b) is a graph illustrating a frequency characteristic of a phase difference when the capacitance value of the variable capacitor 116 is changed from the frequency characteristic of the phase difference shown in FIG. 9(b).

In FIGS. 10(a) and 10(b), measurement is performed under measurement conditions of the respective frequency characteristics in FIGS. 9(a) and 9(b), and the capacitance value of the variable capacitor 116 is measured at 50 fF and 20 fF that are the capacitance values in the measurement in FIG. 9. In FIGS. 10(a) and 10(b), the respective frequency characteristics of the amplitude difference and the phase difference when the capacitance value Cterm of the variable capacitor 116 is 50 fF are indicated by a dotted chain line, and the respective frequency characteristics of the amplitude difference and the phase difference when the capacitance value Cterm of the variable capacitor 116 is 20 fF are indicated by a solid line.

According to the frequency characteristic of the phase difference shown in FIG. 10(b), when the capacitance value Cterm of the variable capacitor 116 is changed from 50 fF to 20 fF, the phase error between the output signals is reduced. On the other hand, according to FIG. 10(a), when the capacitance value Cterm of the variable capacitor 116 is changed from 50 fF to 20 fF, the amplitude error between the output signals is slightly increased.

FIG. 11(a) is a graph illustrating a frequency characteristic of an amplitude difference when the resistance value of the variable resistance 115 is changed from the frequency characteristic of the amplitude difference shown in FIG. 10(a). FIG. 11(b) is a graph illustrating a frequency characteristic of a phase difference when the resistance value of the variable resistance 115 is changed from the frequency characteristic of the phase difference shown in FIG. 10(b).

In FIGS. 11(a) and 11(b), the respective frequency characteristics of the amplitude difference and the phase difference when the resistance value Rterm of the variable resistance 115 is 40Ω are indicated by a dotted chain line, and the respective frequency characteristics of the amplitude difference and the phase difference when the resistance value Rterm of the variable resistance 115 is 60Ω are indicated by a solid line.

According to FIGS. 11(a) and 11(b), when the resistance value Rterm of the variable resistance 115 is changed from 40Ω to 60Ω, the amplitude error and the phase error become approximately 0 dB and 0 degree at 61.5 GHz.

Accordingly, in the quadrature hybrid coupler 100 shown in FIG. 8, even at a high temperature, the frequency characteristics are slightly degraded compared with a room temperature, but by correcting the frequency characteristics using the variable resistance 115 and the variable capacitor 116, it is possible to improve the respective frequency characteristics of the amplitude error and the phase error in a frequency band of 57 to 66 GHz, and to reduce the amplitude error and the phase error.

Specifically, in the quadrature hybrid coupler 100 shown in FIG. 8, even though the ambient temperature is increased to the high temperature (for example, about 80 degrees) from the room temperature, by decreasing the capacitance value of the variable capacitor 116 and increasing the resistance value of the variable resistance 115, it is possible to improve the respective frequency characteristics of the amplitude difference and the phase difference.

Next, the variable capacitor 116 and the variable resistance 115 will be described with reference to FIGS. 12 and 13.

FIG. 12(a) is a diagram illustrating an example of the variable capacitor 116 using a variable capacitance diode. The variable capacitor 116 includes a capacitor C1 having a fixed capacitance value and a variable capacitor C2 using a variable capacitance diode D1. The capacitor C1 and the variable capacitor C2 are connected in series between a terminal N4 and a ground. A cathode of the variable capacitance diode D1 is connected to an end of the capacitor C1 and an end of an inductor LG1. A control voltage VA1 is applied to the other end of the inductor LG1 from the voltage control circuit 117. An anode terminal of the variable capacitance diode D1 is grounded. The other end of the capacitor C1 is connected to the terminal N4.

The control voltage VA1 is changed according to an output voltage Vout1 from the voltage control circuit 117. For example, if the control voltage VA1 is decreased, a reverse bias of the variable capacitance diode is reduced, and the capacitance value of the variable capacitor 116 becomes small.

FIG. 12(b) is a diagram illustrating an example of a variable capacitor using a micro electro mechanical systems (MEMS) variable capacitor. In FIG. 12(b), the same reference numerals are given to sections common to the configuration shown in FIG. 12(a). In the variable capacitor 116 shown in FIG. 12(b), the variable capacitor C2 shown in FIG. 12(a) is formed using the MEMS structure.

Specifically, the MEMS variable capacitor includes an electrode 1 that is a fixed electrode provided on a semiconductor substrate, and an electrode 3 that is a variable electrode provided on the semiconductor substrate. In the MEMS variable capacitor, the electrode 3 that faces the electrode 1 is disposed on the electrode 1 on the semiconductor substrate through a dielectric layer 2.

The electrode 3 is an electrode in which metal is layered on a thick film in which plural material layers are overlapped, and is movably supported through a spring, for example.

As an electric potential of the electrode 3 is changed according to the control voltage VA1 and the distance between the electrode 1 and the electrode 3 is changed according to electrostatic attraction, the capacitance value is changed. For example, if the control voltage VA1 is decreased, the distance between the electrodes is increased, and the capacitance value is decreased.

Accordingly, in both of the variable capacitor using the variable capacitance diode and the MEMS variable capacitor, the capacitance values are decreased according to reduction in the control voltage VA1.

FIG. 13 is a diagram illustrating an example of the variable resistance 115 using a field effect transistor M1. The variable resistance 115 includes an N-type field effect transistor M1. A control voltage VA2 from the voltage control circuit 117 is applied to a gate of the field effect transistor M1 from through a resistance R1. Since a substantial resistance between a source and a drain of the field effect transistor M1 is changed according to the voltage applied to the gate, the field effect transistor M1 becomes a variable resistance. For example, the resistance value is increased according to reduction in the control voltage VA2.

Next, a circuit configuration of the voltage control circuit 117 and the temperature sensor 118 will be described with reference to FIG. 14. FIG. 14 is a diagram illustrating a circuit configuration of an example of the voltage control circuit 117 and the temperature sensor 118.

The temperature sensor 118 includes PNP bipolar transistors 201, 202 and 206 that form a current mirror, NPN bipolar transistors 203 and 204 that form the current mirror, and a voltage-current conversion resistance 205. The PNP bipolar transistors 201 and 202, the NPN bipolar transistors 203 and 204, and the resistance 205 are referred to as a proportional to absolute temperature (PTAT) circuit. If the atmospheric temperature is increased, an output current Ic3 of the PNP bipolar transistor 206 is increased.

The voltage control circuit 117 includes NPN bipolar transistors 207, 208 and 211 that form a current mirror, resistances 209 and 210 that are serially connected, and resistances 212 and 213 that are serially connected. The NPN bipolar transistors 207, 208 and 211 form a current mirror circuit.

An output voltage Vout1 is obtained from a common connection point of the resistance 209 and the resistance 210, and an output voltage Vout2 is obtained from a common connection point of the resistance 212 and the resistance 213. The resistance value of the variable resistance 115 is changed according to the output voltage Vout1, and the capacitance value of the variable capacitor 116 is changed according to the output voltage Vout2. The resistances 209, 210, 212 and 213 determine the gradients of the temperature characteristics of the output voltages Vout1 and Vout2.

The output voltages Vout1 and Vout2 are respectively determined by a division ratio of the resistance 212 and the resistance 213 and a division ratio of the resistance 209 and the resistance 210. The output voltages Vout1 and Vout2 are respectively decreased as the atmospheric temperature (ambient temperature) is increased. The temperature characteristics of the output voltages Vout1 and Vout2 based on the atmospheric temperature are respectively determined according to a resistance value ratio of the resistance 212 and the resistance 213 and a resistance value ratio of the resistance 209 and the resistance 210.

Next, an operation of the temperature sensor 118 will be described. Here, a voltage between a base and an emitter of the NPN bipolar transistor 203 is set to Vbe1, a voltage between a base and an emitter of the NPN bipolar transistor 204 is set to Vbe2, and a resistance value of the resistance 205 is set to R. A collector current Ic1 of the NPN bipolar transistor 204 becomes (Vbe1−Vbe2)/R.

The resistance value R of the resistance 205 has temperature dependency on the atmospheric temperature, and is increased according to temperature increase. The voltages between the bases and the emitters of the NPN bipolar transistors 203 and 204 also have temperature dependency, and are decreased if the ambient temperatures are increased.

If the NPN bipolar transistor 203 and the NPN bipolar transistor 204 are biased at different current densities, the variation rates to temperature of the voltage Vbe1 and the voltage Vbe2 are changed. A current density J2 of a current that flows in the NPN bipolar transistor 204 is set to be n times (n is an integer larger than 1) a current density J1 of a current that flows in the NPN bipolar transistor 203.

The value of (Vbe1−Vbe2) is increased according to temperature increase. That is, if temperature is increased, an electric potential of one end of the resistance 205 is proportionally increased. Accordingly, it is possible to compensate current reduction due to increase in the resistance value R of the resistance 205 according to temperature increase, by the increase in the electric potential of one end of the resistance 205. Thus, an emitter current (approximately equivalent to the collector current Ic1) of the NPN bipolar transistor 204 may be increased with respect to the ambient temperature according to increase in (Vbe1−Vbe2) and the gradient determined according to increase in the resistance value R of the resistance 205.

Currents Ic2 and Ic3 are generated on the basis of the current Ic1 having a gradient characteristic to temperature. The current ratio of the currents Ic1, Ic2 and Ic3 may be determined by the current mirror ratio. The current Ic3 has a characteristic that it increases in proportion to the ambient temperature with a predetermined gradient, which becomes an output current of the temperature sensor 118.

Next, an operation of the voltage control circuit 117 will be described.

The voltage control circuit 117 generates currents Ic4 and Ic5 determined according to the current mirror ratio on the basis of the output current Ic3 from the temperature sensor 118. As the current Ic4 flows in the resistance 210, a voltage drop occurs on both ends of the resistance 210. The amount of voltage drop may be adjusted according to the resistance value of the resistance 210 on the basis of the fixed current Ic4. That is, it is possible to adjust the amount of voltage drop on both ends of the resistance 210 according to the division ratio of a power voltage Vcc of the resistance 210 and the resistance 209.

That is, if the ambient temperature is increased, the current Ic4 is increased, and the amount of voltage drop of the resistance 210 is increased. Thus, the voltage value of the output voltage Vout1 is decreased. The amount of voltage decrease may be adjusted according to the gradient determined by the division ratio of the resistance 209 and the resistance 210.

This is similarly applied to the current Ic5 and the resistances 212 and 213. That is, if the ambient temperature is increased, the current Ic5 is increased, and the amount of voltage drop of the resistance 213 is increased. Thus, the voltage value of the output voltage Vout2 is decreased. The amount of voltage decrease may be adjusted according to the gradient determined by the division ratio of the resistance 212 and the resistance 213.

For generation of the control voltages VA1 and VA2, in the example in FIG. 14, a current source circuit is used as the temperature sensor 118 and an inverting amplifier of a current-voltage conversion type is used as the voltage control circuit 117, and thus, it is possible to form the temperature sensor 118 and the voltage control circuit 117 with a simple structure. Accordingly, it is possible to reduce the voltage control circuit 117 and the temperature sensor 118 in size, and to easily mount them on IC.

### Third Embodiment

In the present embodiment, an amplifier (Doherty amplifier) using the quadrature hybrid coupler according to any one of the respective embodiments described above will be described. FIG. 15 is a block diagram illustrating an internal configuration of an amplifier 700 according to a third embodiment. The amplifier (Doherty amplifier) shown in FIG. 15 includes a quadrature hybrid coupler 701 according to any one of the respective embodiments described above, a main amplifier 702, a ¼ wavelength transmission line 703 and a peak amplifier 704.

In FIG. 15, an input signal IN is branched into two output signals having a phase difference of 90 degrees by the quadrature hybrid coupler 701. A signal (Q signal) of which the phase is shifted by 90 degrees is input to the main amplifier 702, a signal (I signal) of which the phase is not shifted is input to the peak amplifier 704.

The main amplifier 702 amplifies the Q signal, and the peak amplifier 704 amplifies the I signal. An output signal from the main amplifier 702 is input to the ¼ wavelength transmission line 703, and is delayed in phase by 90 degrees in the ¼ wavelength transmission line 703. An output signal from the ¼ wavelength transmission line 703 and an output signal from the peak amplifier 704 are combined, and is output as an output signal OUT from the amplifier 700.

In the amplifier 700, the phase of the output signal from the main amplifier 702 is delayed by 90 degrees in the ¼ wavelength transmission line 703. Thus, it is assumed that the output signal from the main amplifier 702 and the output signal from the peak amplifier 704 have the same phase. Accordingly, it is necessary that the input signal of the main amplifier 702 be branched to two output signals of the phase difference of 90 degrees in the quadrature hybrid coupler 701. A phase error of the quadrature hybrid coupler 701 becomes a cause of combination loss in the output signal from the amplifier 700. Since the amplifier 700 of the present embodiment uses the quadrature hybrid coupler according to any one of the respective embodiments described above, it is possible to reduce output loss, and to improve amplification efficiency

### Fourth Embodiment

In the present embodiment, a wireless communication device using the quadrature hybrid coupler according to any one of the respective embodiments described above will be described with reference to FIG. 16. FIG. 16 is a block diagram illustrating an internal configuration of a wireless communication device 600 according to a fourth embodiment.

The wireless communication device 600 shown in FIG. 16 includes a transmission RF amplifier 603 to which a transmission antenna 601 is connected, a reception RF amplifier 604 to which a reception antenna 602 is connected, a quadrature modulator 605, a quadrature demodulator 606, the quadrature hybrid couplers 607 and 608 according to any one of the respective embodiments described above, a switch 609, an oscillator 610, a phase locked loop (PLL) 611, analogue baseband circuits 612 and 613, and a digital baseband circuit 614.

An operation of the wireless communication device 600 will be described.

A local signal generated by the oscillator 610 and the PLL 611 is input to the quadrature hybrid coupler 607 of a transmission side or the quadrature hybrid coupler 608 on a reception side through the switch 609. The local signal is a high frequency signal at a band of 60 GHz, for example. The local signal input to the quadrature hybrid coupler 607 of the transmission side is branched to two output signals having the same amplitude and a phase difference of 90 degrees by the quadrature hybrid coupler 607. The branched two output signals are input to the quadrature modulator 605.

The local signal input to the quadrature hybrid coupler 608 on a reception side is branched two output signals having the same amplitude and a phase difference of 90 degrees by the quadrature hybrid coupler 608. The branched two output signals are input to the quadrature demodulator 606.

A transmission baseband signal generated by the digital baseband circuit 614 is digital-analogue-converted, amplified and filtered by the analogue baseband circuit 612, and is converted to a transmission RF signal in the quadrature modulator 605 on the basis of the output signal from the quadrature hybrid coupler 607. The RF (radio frequency) signal is amplified in the transmission RF amplifier 603, and then is radiated from the transmission antenna 601.

In the wireless communication device 600, in order to branch a high frequency local signal to an I signal and a Q signal having the same amplitude and a phase difference of 90 degrees, the quadrature hybrid coupler 607 according to any one of the respective embodiments described above is used.

Further, since the wireless communication device 600 can adjust the frequency characteristic of the quadrature hybrid coupler 617 by adjustment of the variable capacitor and the variable resistance, it is possible to improve modulation accuracy of the quadrature modulator 605.

Further, a reception RF signal received through the antenna 602 is amplified in the reception RF amplifier 604, and then is converted to a reception baseband signal in the quadrature demodulator 606 on the basis of the output signal from the quadrature hybrid coupler 608.

Further, since the wireless communication device 600 can adjust the frequency characteristic of the quadrature hybrid coupler 618 by adjustment of the variable capacitor and the variable resistance, it is possible to improve demodulation accuracy of the quadrature demodulator 606.

The reception baseband signal is analogue-digital-converted, amplified and filtered in the analog baseband circuit 613, and then is demodulated in the digital baseband circuit 614.

As described above, by applying the quadrature hybrid coupler according to any one of the respective embodiments described above to the wireless communication device 600 of the present embodiment, it is possible to improve modulation accuracy of the quadrature modulator 605 and demodulation accuracy of the quadrature demodulator 606. That is, the wireless communication device 600 can improve signal quality of the transmission signal, and can improve reception sensitivity.

### Modification Example of the Fourth Embodiment

In the present embodiment, a wireless communication device 800 according to a modification example of the fourth embodiment will be described with reference to FIG. 17. FIG. 17 is a block diagram illustrating an internal configuration of the wireless communication device 800 according to the modification example of the fourth embodiment. In FIG. 17, the same reference numerals are given to the same configuration as that of the wireless communication device 600 shown in FIG. 16, the description thereof will be simplified or omitted, and only the contents different will be described.

In the wireless communication device 800 shown in FIG. 17, a quadrature hybrid coupler 807 is provided between the transmission RF amplifier 603 and a quadrature modulator 805, and a quadrature hybrid coupler 808 is provided between the reception RF amplifier 604 and a quadrature demodulator 806.

That is, the quadrature hybrid coupler 807 receives two output signals (I signal and Q signal) from the quadrature modulator 805, combines two input signals to form one output signal, and outputs the output signal to the transmission RF amplifier 603.

Further, in the wireless communication device 800 shown in FIG. 17, the quadrature hybrid coupler 807 branches the RF signal output from the reception RF amplifier 604 to an I signal and a Q signal, and outputs the signals to the quadrature demodulator 806.

The wireless communication device 800 shown in FIG. 17 is particularly effective in a case where the quadrature modulator 805 and the quadrature demodulator 806 are sub-harmonic mixers, that is, mixers in which the frequency of the local signal corresponds to a value obtained by dividing an RF frequency by an integer.

As described above, by applying the quadrature hybrid coupler according to any one of the respective embodiments described above to the wireless communication device 800 of the present embodiment, it is possible to improve modulation accuracy of the quadrature modulator 805 and demodulation accuracy of the quadrature demodulator 806. That is, the wireless communication device 800 can improve signal quality of the transmission signal, and can improve reception sensitivity.

Hereinbefore, various embodiments have been described with reference to the accompanying drawings, but the present disclosure is not limited to these examples. It will be obvious to those skilled in the art that modification examples or revision examples and combination examples of the various embodiments may be made within a range without departing from the disclosure of claims, which are considered to be included in the technical scope of the present disclosure.

The application range of the quadrature hybrid coupler is wide, and for example, the quadrature hybrid coupler may be used as a complex mixer. Further, for example, the quadrature hybrid coupler may be also used as a circuit with much freedom to create a phase difference in the IQ phase plane. Further, if an on-chip spiral inductor is used as an inductive coupling element (transformer), then the inductive coupling element may be built in an IC, and is suitable for a small device. Further, the shunt capacitor or the like may be manufactured by an IC manufacturing method, which is suitable of mass production.

The phase shifters 112 and 113 in the respective embodiments described above are not limited to the configuration using the coplanar transmission line, and for example, a configuration using a microstrip transmission line or a strip transmission line may be also used.

The present application is based on Japanese Patent Application No. 2012-000794 filed on Jan. 5, 2012, the contents of which are incorporated herein by reference.

### INDUSTRIAL APPLICABILITY

The present disclosure is useful for a quadrature hybrid coupler, an amplifier and a wireless communication device in which frequency characteristics of amplitude error and phase error in a high frequency signal are improved.

### REFERENCE SIGNS LIST

90: Coupling section
100: Quadrature hybrid coupler
101: Transformer
102, 103: Coupling capacitor
104 to 107: Shunt capacitor
108: Termination resistance
109, 110: Parasitic resistance of transformer
111: Termination capacitor
112, 113: Phase shifter

1. A quadrature hybrid coupler comprising:
a transformer that includes a first terminal, a second terminal, a third terminal and a fourth terminal;
a first coupling capacitor that is provided between the first terminal and the third terminal;
a second coupling capacitor that is provided between the second terminal and the fourth terminal;
a first shunt capacitor, a second shunt capacitor, a third shunt capacitor and a fourth shunt capacitor that are respectively provided with the first terminal, the second terminal, the third terminal and the fourth terminal;
a termination resistance that is connected to the fourth terminal;
a termination capacitor that is connected to the fourth terminal and is connected in parallel with the termination resistance;
a first phase shifter that is connected to the second terminal; and
a second phase shifter that is connected to the third terminal, wherein
a phase delay amount of the second phase shifter is larger than a phase delay amount of the first phase shifter.

2. The quadrature hybrid coupler according to claim 1, wherein
the first phase shifter is configured using a first transmission line,
the second phase shifter is configured using a second transmission line, and
a line length of the second transmission line is longer than a line length of the first transmission line.

3. The quadrature hybrid coupler according to claim 2, wherein
each of the first and second transmission lines is configured using a coplanar transmission line.

4. The quadrature hybrid coupler according to claim 1, wherein
each of the first and second phase shifters is configured using a plurality of inductors and a plurality of shunt capacitors, and
a capacitance value of the shunt capacitors of the second phase shifter is larger than a capacitance value of the shunt capacitors of the first phase capacitor.

5. The quadrature hybrid coupler according to claim 1, wherein
the termination resistance is a variable resistance, and
the termination capacitor is a variable capacitor.

6. The quadrature hybrid coupler according to claim 1, further comprising:
a temperature sensor, configured to detect an ambient temperature of the quadrature hybrid coupler, and
a voltage control circuit, configured to output a control voltage for control of a resistance value and a capacitance value of the termination resistance and the terminal capacity according to the ambient temperature.

7. The quadrature hybrid coupler according to claim 6, wherein
the voltage control circuit generates the control voltage by which the resistance value of the variable resistance is increased and the capacitance value of the variable capacitor is decreased as the ambient temperature is increased.

8. The quadrature hybrid coupler according to claim 1, wherein
the fourth shunt capacitor and the termination capacitor are a common capacitor having a capacitance value larger than that of each of the first, second and third shunt capacitor.

9. The quadrature hybrid coupler according to claim 1, wherein
an input signal is input to the first terminal, and
two output signals having a same amplitude and a phase difference of 90 degrees therebetween are respectively output from the first shifter and the second shifter.

10. The quadrature hybrid coupler according to claim 1, wherein
two input signals having a same amplitude and a phase difference of 90 degrees therebetween are respectively input to the first shifter and the second shifter, and
one output signal is output from the first terminal.

11. An amplifier comprising:
the quadrature hybrid coupler according to claim 1;
a main amplifier, configured to amplify one output signal from the quadrature hybrid coupler;
a peak amplifier, configured to amplify the other output signal from the quadrature hybrid coupler, and
a ¼ wavelength line, configured to delay phase of the output signal from the main controller by 90 degrees.

12. A wireless communication device comprising:
a local signal generator, configured to generate a local signal;
first and second quadrature hybrid couplers according to claim 9, configured to output two signals having a same amplitude and a phase difference of 90 degrees therebetween based on the generated local signal;
a quadrature modulator, configured to quadrature-modulate a transmission signal based on two output signals from the first quadrature hybrid coupler; and
a quadrature-demodulator, configured to quadrature-demodulate a reception signal based on two output signals from the second quadrature hybrid coupler.

13. A wireless communication device comprising:
a local signal generator, configured to generate a local signal;
a quadrature modulator, configured to quadrature-modulate two input signals having a phase difference of 90 degrees therebetween based on the generated local signal;
the quadrature hybrid coupler according to claim 10, configured to advance or delay, by 90 degrees, the phase of one input signal among the two quadrature-modulated input signals having the phase difference of 90 degrees therebetween; and
a transmission RF amplifier, configured to amplify an output signal from the quadrature hybrid coupler.
